(19) United States
(12) Patent Application Publication
(10) Pub. No.: US 2007/0085958 A1
(43) Pub. Date: Apr. 19, 2007

(54) Liquid crystal display having common and pixel electrodes on both of substrates thereof

(75) Inventors: Yu-Cheng Lin, Miao-Li (TW); Chueh-Ju Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/580,566

(22) Filed: Oct. 12, 2006

(30) Foreign Application Priority Data
Oct. 13, 2005 (TW) 200510100412.3

(51) Int. Cl. G02F 1/1343

(52) U.S. Cl. 349/141

(57) ABSTRACT

An exemplary liquid crystal display (LCD) (200) includes a first substrate (211), a second substrate (212) opposite to the first substrate, a liquid crystal layer (213) sandwiched between the first substrate and the second substrate, a plurality of first common electrodes (241) and first pixel electrodes (242) provided. at the first substrate, and a plurality of second common electrodes (251) and second pixel electrodes (252) provided at the second substrate. The first common electrodes and the first pixel electrodes, and the second common electrodes and the second pixel electrodes, respectively produce two electric fields in the liquid crystal layer. A combined strength of the electric fields is uniformly distributed in the liquid crystal layer, so that all the liquid crystal molecules can be sufficiently twisted. Thus a viewing angle, a degree of chroma, and a transmission ratio of the LCD are improved.

### FIELD OF THE INVENTION

The present invention relates to liquid crystal displays, and particularly to a liquid crystal display having a plurality of common and pixel electrodes on both of substrates thereof.

### GENERAL BACKGROUND

A liquid crystal display (LCD) utilizes the optical and electrical anisotropy of liquid crystal molecules to produce an image. The liquid crystal molecules have a particular passive orientation when no voltage is applied thereto. However, in a driven state, the liquid crystal molecules change their orientation according to the strength and direction of the driving electric field. A polarization state of incident light changes when the light transmits through the liquid crystal molecules, due to the optical anisotropy of the liquid crystal molecules. The extent of the change depends on the orientation of the liquid crystal molecules. Thus, by properly controlling the driving electric field, an orientation of the liquid crystal molecules is changed and a desired image can be produced.

The first type of LCD developed was the TN (twisted nematic) mode LCD. Even though TN mode LCDs have been put into use in many applications, they have an inherent drawback that cannot be eliminated; namely, a very narrow viewing angle. By adding compensation films on TN mode LCDs, this problem can be mitigated to some extent. However, the cost of the TN mode LCD is increased. Therefore, a totally different driving means called IPS (in-plane switching) was proposed as early as 1974. Then in 1993, Hitachi Corporation filed its first US patent application concerning IPS, in which an IPS mode LCD was disclosed.

Referring to FIG. 5, a typical IPS LCD 100 includes a first substrate 111, a second substrate 112 opposite and parallel to the first substrate 111, a liquid crystal layer 113 sandwiched between the first and second substrates 111, 112, two polarizers 121, 122, a color filter 130, two alignment layers 131, 132, an insulating layer 135, and a passivation layer 143. The liquid crystal layer 113 includes a multiplicity of nematic liquid crystal molecules. The polarizers 121, 122 are disposed at outer sides of the substrates 111, 112 respectively. Polarizing axes of the two polarizers 121, 122 are perpendicular to each other. The color filter 130 and the alignment layer 131 are disposed between the first substrate 111 and the liquid crystal layer 113, in that order from top to bottom. The alignment layer 132, the passivation layer 143, and the insulating layer 135 are disposed one on the other between the liquid crystal layer 113 and the second substrate 112, in that order from top to bottom. The IPS LCD 100 further includes a plurality of common electrodes 141 and a plurality of pixel electrodes 142 parallel to each other. The pixel electrodes 141 are disposed in the insulating layer 135. The common electrodes 142 are disposed in the passivation layer 143. At least one of the substrates 111, 112 is made from a transparent material, such as glass. Original rubbing directions of the alignment layers 131, 132 are parallel to each other, and are identical to a polarizing axis of the polarizer 122.

When no voltage is applied to the common and pixel electrodes 141, 142, the long axes of the liquid crystal molecules is in the rubbing direction of the alignment layers 131, 132. Because the rubbing direction of the alignment layers 131, 132 is the same as the polarizing axis of the polarizer 122, light beams passing through the polarizer 122 can pass through the liquid crystal layer 113, and polarizing directions of the light beams do not change. Because the polarizing axes of the polarizers 121, 122 are perpendicular to each other, the light beams cannot pass through the polarizer 121, and are absorbed by the polarizer 121. Thus the IPS LCD 100 is in an “off” state, and cannot display images.

As shown in FIG. 6, when a voltage is applied to the common and pixel electrodes 141, 142, an electric field 114 is generated between the common and pixel electrodes 141, 142. A direction of the electric field 114 is parallel to the second substrate 112, and perpendicular to the pixel and common electrodes 141, 142. The long axes of the liquid crystal molecules twist to align in the direction of the electric field 114. When light beams pass through the liquid crystal layer 113, the polarization state of the light beams is converted to match the polarizing axis of the polarizer 121. Thus the light beams pass through the polarizer 121 to display images, and the IPS LCD 100 is in an “on” state.

However, because the common electrode 141 and the pixel electrode 142 are both disposed adjacent to the second substrate 112, and the liquid crystal layer 113 has a certain thickness, it is difficult for the electric field 114 between the common and pixel electrodes 141, 142 to grasp those liquid crystal molecules that are distal from the second substrate 112. Thus such liquid crystal molecules cannot be readily or fully twisted to a predetermined angle in the electric field 114, such that a viewing angle, a degree of chroma, and a transmission ratio of the IPS LCD 100 are decreased.

Therefore, a new LCD that can overcome the above-described problems is desired.

### SUMMARY

In a preferred embodiment, a liquid crystal display includes a first substrate, a second substrate opposite to the first substrate, a liquid crystal layer sandwiched between the first substrate and the second substrate, a plurality of first common electrodes and first pixel electrodes provided at the first substrate, and a plurality of second common electrodes and second pixel electrodes provided at the second substrate.

Other advantages and novel features will become more apparent from the following detailed description when taken in conjunction with the accompanying drawings.

### BRIEF DESCRIPTION OF THE DRAWINGS

FIG. 1 is a schematic, side cross-sectional view of part of an IPS LCD according to a first embodiment of the present invention, showing the IPS LCD in an on state.

FIG. 2 is an enlarged plan view of pixel and common electrodes of the IPS LCD shown in FIG. 1.

FIG. 3 is similar to FIG. 2, but showing a corresponding view in the case of pixel and common electrodes of an IPS LCD according to a second embodiment of the present invention.

FIG. 4 is similar to FIG. 2, but showing a corresponding view in the case of pixel and common electrodes of an IPS LCD according to a third embodiment of the present invention.

FIG. 5 is a schematic, side cross-sectional view of part of a conventional IPS LCD, showing the IPS LCD in an off state.

FIG. 6 is similar to FIG. 5, but showing the IPS LCD in an on state.

### DETAILED DESCRIPTION OF PREFERRED EMBODIMENTS

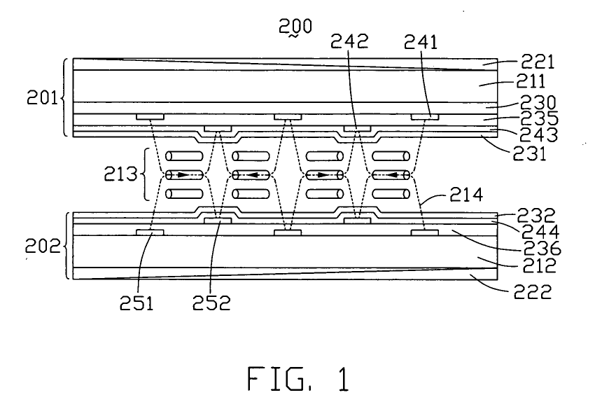

Referring to FIG. 1, an LCD 200 according to a first embodiment of the present invention includes a first substrate assembly 201, a second substrate assembly 202 opposite and parallel to the first substrate 201, and a liquid crystal layer 213 sandwiched between the first and second substrate assemblies 201, 202.

The first substrate assembly 201 includes a first polarizer 221, a first substrate 211, a color filter 230, a first insulating layer 235, a first passivation layer 243, and a first alignment layer 231, disposed in that order from top to bottom. The first substrate assembly 201 further includes a plurality of first common electrodes 241 disposed on an inner surface of the color filter 230 and a plurality of first pixel electrodes 242 disposed on an inner surface of the first insulating layer 235. The first common electrodes 241 and the first pixel electrodes 242 are alternately arranged.

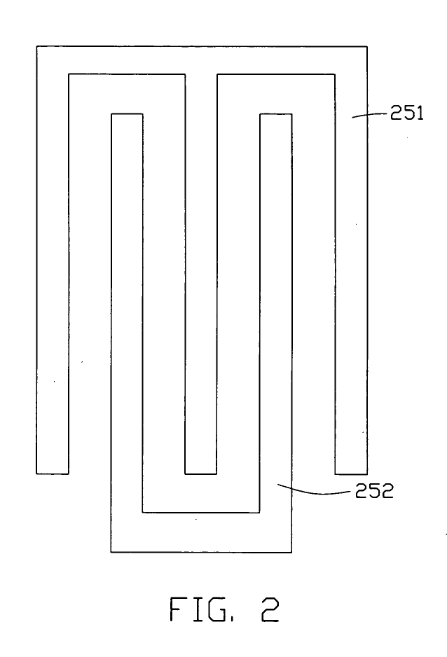

The second substrate assembly 202 includes a second alignment layer 232, a second passivation layer 244, a second insulating layer 236, a second substrate 212, and a second polarizer 222 disposed in that order, from top to bottom. The second substrate assembly 202 further includes a plurality of second common electrodes 251 disposed on an inner surface of the second substrate 212 and a plurality of second pixel electrodes 252 disposed on an inner surface of the second insulating layer 236. The second common electrodes 251 and the second pixel electrodes 252 are alternately arranged. Each second common electrode 251 corresponds to a respective first common electrode 241. Each second pixel electrode 252 corresponds to a respective first pixel electrode 242. Referring to FIG. 2, the electrodes 251, 252 are strip-shaped, and extend from a straight bus line. Correspondingly, the electrodes 241, 242 are also strip-shaped, and extend from a straight bus line. Original rubbing directions of the first and second alignment layers 231, 232 are the same as a polarizing axis of the second polarizer 222.

The first and second substrates 211, 212 are made from a transparent material, such as glass or quartz. The liquid crystal layer 213 includes a plurality of nematic-type liquid crystal molecules. The electrodes 241, 242, 251, 252 may be made from a transparent electrically conductive material such as indium-zinc-oxide (IZO) or indium-tin-oxide (ITO), or from material including any one or more items selected from the group consisting of aluminum, gold, silver, chromium, nickel, titanium, copper, molybdenum, niobium, and an electrically conductive alloy.

As shown in FIG. 1, when a voltage is applied to the common and pixel electrodes 241, 251, 242, 252, two electric fields 214 are generated: one between the first common electrodes 241 and the first pixel electrodes 242, and the other between the second common electrodes 251 and the second pixel electrodes 252. The electric fields 214 are substantially parallel to the first and second substrates 211, 212. Because the liquid crystal molecules have anisotropic properties, they are controlled by the electric fields 214, so that directions of long axes of the liquid crystal molecules conform to directions of the electric fields 214. Those liquid crystal molecules distal from the first substrate 211 are driven more strongly by the electric field 214 produced by the second common electrodes 251 and the second pixel electrodes 252, and driven relatively weakly by the electric field 214 produced by the first common electrodes 241 and the first pixel electrodes 242. Those liquid crystal molecules distal from the second substrate 212 are driven more strongly by the electric field 214 produced by the first common electrodes 241 and the first pixel electrodes 242, and driven relatively weakly by the electric field 214 produced by the second common electrodes 251 and the second pixel electrodes 252. That is, overall, the liquid crystal molecules of the liquid crystal layer 213 distributed along any given path normal to the first substrate 211 and the second substrate 212 are driven equally by the two electric fields 214 acting cooperatively.

In summary, the first common electrodes 241 and the first pixel electrodes 242, and the second common electrodes 251 and the second pixel electrodes 252, respectively produce two electric fields 214 in the liquid crystal layer 213. A combined strength of the electric fields 214 is uniformly distributed in the liquid crystal layer 213, so that all the liquid crystal molecules can be sufficiently twisted. In particular, all the liquid crystal molecules in each of pixel regions defined by the electrodes 241, 242, 251, 252 can be sufficiently and uniformly twisted. That is, even those liquid crystal molecules distal from either of the substrates 211, 212 can be grasped by the combined electric fields 214 produced by the electrodes 241, 242, 251, 252 and twisted to a predetermined angle. Thus a viewing angle, a degree of chroma, and a transmission ratio of the LCD 200 are improved.

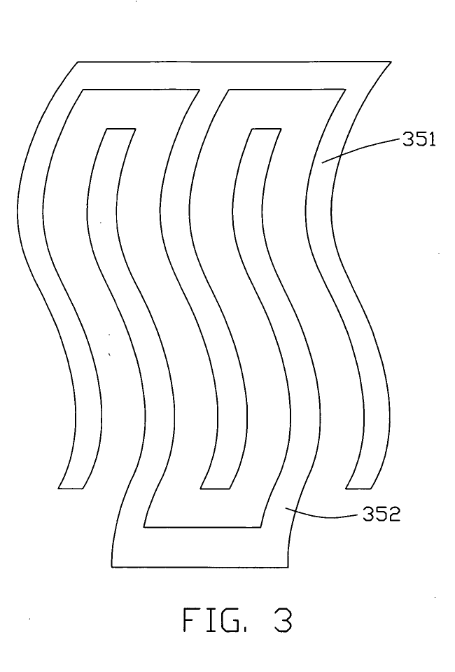

FIG. 3 shows common electrodes 351 and pixel electrodes 352 of an LCD according to a second embodiment of the present invention. The common electrodes 351 and pixel electrodes 352 are generally S-shaped or wavy.

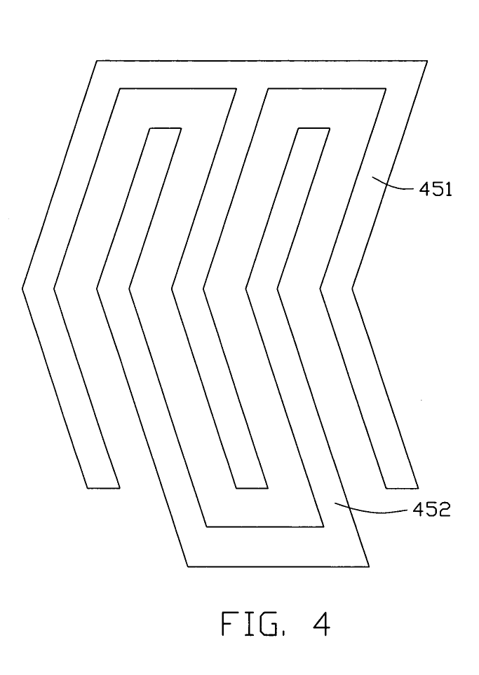

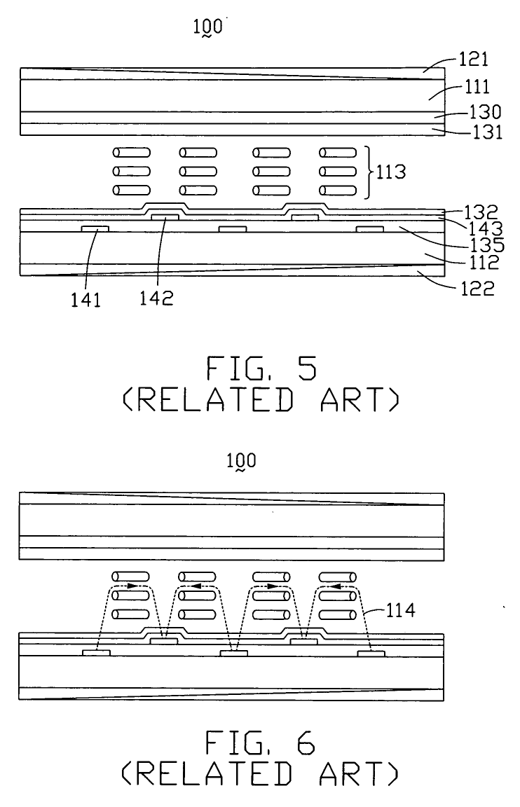

FIG. 4 shows common electrodes 451 and pixel electrodes 452 of an LCD according to a third embodiment of the present invention. The common electrodes 451 and pixel electrodes 452 are rectilinearly bent or generally zigzag-shaped.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display comprising:
a first substrate;
a second substrate opposite to the first substrate;
a liquid crystal layer sandwiched between the first substrate and the second substrate;
a plurality of first common electrodes and first pixel electrodes provided at the first substrate; and
a plurality of second common electrodes and second pixel electrodes provided at the second substrate.

2. The liquid crystal display as claimed in claim 1, wherein each first common electrode corresponds to a respective second common electrode, and each first pixel electrode corresponds to a respective second pixel electrode.

3. The liquid crystal display as claimed in claim 1, wherein the first and second substrates are each made from transparent material.

4. The liquid crystal display as claimed in claim 3, wherein the transparent material is glass.

5. The liquid crystal display as claimed in claim 3, wherein the transparent material is quartz.

6. The liquid crystal display as claimed in claim 1, wherein the first and second common electrodes and the first and second pixel electrodes are made from electrically conductive material.

7. The liquid crystal display as claimed in claim 6, wherein the conductive material is transparent conductive material.

8. The liquid crystal display as claimed in claim 7, wherein the transparent conductive material is indium-zinc-oxide (IZO).

9. The liquid crystal display as claimed in claim 7, wherein the transparent conductive material is indium-tin-oxide (ITO).

10. The liquid crystal display as claimed in claim 6, wherein the conductive material includes any one or more items selected from the group consisting of aluminum, gold, silver, chromium, nickel, titanium, copper, molybdenum, niobium, and an electrically conductive alloy.

11. The liquid crystal display as claimed in claim 1, wherein the first and second common electrodes and the first and second pixel electrodes are strip-shaped.

12. The liquid crystal display as claimed in claim 1, wherein the first and second common electrodes and the first and second pixel electrodes are generally S-shaped or wavy.

13. The liquid crystal display as claimed in claim 1, wherein the first and second common electrodes and the first and second pixel electrodes are rectilinearly bent or generally zigzag-shaped.

14. The liquid crystal display as claimed in claim 1, further comprising a color filter, an insulating layer, a passivation layer, and an alignment layer provided in that order on an inner surface of the first substrate.

15. The liquid crystal display as claimed in claim 14, wherein the first common electrodes are disposed on an inner surface of the color filter, and the first pixel electrodes are disposed on an inner surface of the insulating layer.

16. The liquid crystal display as claimed in claim 15, further comprising a polarizer provided on an outer surface of the first substrate.

17. The liquid crystal display as claimed in claim 1, further comprising an insulating layer, a passivation layer, and an alignment layer provided in that order on an inner surface of the second substrate.

18. The liquid crystal display as claimed in claim 17, wherein the second common electrodes are disposed on an inner surface of the second substrate, and the second pixel electrodes are disposed on an inner surface of the insulating layer.

19. The liquid crystal display as claimed in claim 18, further comprising a polarizer provided on an outer surface of the second substrate.

20. The liquid crystal display as claimed in claim 1, wherein the liquid crystal layer comprises a plurality of nematic-type liquid crystal molecules.
